(19) United States
(12) Patent Application Publication
(10) Pub. No.: US 2024/0093121 A1
(43) Pub. Date: Mar. 21, 2024

(54) SOLVENT VAPORS ABSORPTION SYSTEM REDUCING CONTAMINATIONS

(71) Applicant: DESMET BELGIUM, ZAVENTEM (BE)

(72) Inventors: Timothy KEMPER, Marietta, GA (US); Francisco RAMÓN PEREZ VASQUEZ, Woluwe-Saint-Lambert (BE)

(73) Assignee: DESMET BELGIUM, ZAVENTEM (BE)

(21) Appl. No.: 18/368,612

(22) Filed: Sep. 15, 2023

Related U.S. Application Data
(60) Provisional application No. 63/406,730, filed on Sep. 15, 2022.

(51) Int. Cl. C11B 3/14; B01D 3/34; B01D 3/38

(52) U.S. Cl. CPC C11B 3/14; B01D 3/346; B01D 3/38

(57) ABSTRACT

The invention relates to a process for improving the efficiency of solvent vapors absorption system and in particular it relates to a continuous process reducing the contaminants released by said solvent vapors absorption system i.e., the concentration of solvent contaminating the discharged air can be reduced by a factor 10 and/or the concentration of the liquid contaminating the recovered solvent is reduced to level below detection limit.

### CROSS REFERENCE TO RELATED APPLICATION

This application claims the priority benefit of U.S. Patent Application No. 63/406,730, filed on Sep. 15, 2022, entitled “IMPROVED SOLVENT VAPORS ABSORPTION SYSTEM REDUCING CONTAMINATIONS”, which is incorporated herein by reference in its entirety.

### TECHNICAL FIELD

The present invention relates to a process for improving the efficiency of a solvent vapors absorption system used in the field of the solvent extraction of vegetable oil from oleaginous materials. In particular, it reduces considerably the contaminants released by said solvent vapors absorption system, i.e., the present invention significantly reduces the solvent vapors emissions and the vegetable oil contamination with the liquid used in the solvent vapors absorption system.

### BACKGROUND OF THE INVENTION

One of the streams generated by solvent extraction facilities processing oleaginous vegetable material (such as soybean, rapeseed, sunflower seeds for example), is composed by a mixture of air and solvent vapors containing typically about 30% to about 60% of solvent (w/w). Solvent is usually commercial hexane (also known as “extraction hexane”) which is a mix of n-hexane and its isomers. Such standard solvent will simply be referred to as “hexane” in this document.

The air/solvent vapors stream usually results from the merging of various air/solvent vapors streams generated by several items of such solvent extraction facilities as the solvent extractor per se, but also for example, the vacuum condenser from the solvent distillation unit, and the meal desolventizer.

The air fraction of the air/solvent vapors stream originates mainly from the air contained in the oleaginous vegetable material that is constantly fed to the solvent extractor, but the air may originate also from small air ingresses into the various items composing the solvent extraction facility. As a matter of fact, most of those items are purposely kept slightly below atmospheric pressure to avoid fugitive solvent escape to the atmosphere which would be inacceptable from a safety and air emission regulations point of view. Consequently, this final air/solvent vapors stream must be desolventized before being discharged to the atmosphere.

Accordingly, the air/solvent vapors stream is treated by a solvent vapors absorption system in order to remove and recover most of the solvent so as to avoid contamination by excessive solvent discharge to the atmosphere and comply to the local air emission and safety regulations. The recovered solvent is subsequently condensed and recycled in the solvent extractor. Therefore, the solvent vapors absorption system has also an inherent function of limiting solvent losses and therefore limits the solvent consumption by reducing the solvent make-up.

In the solvent extraction of oleaginous vegetable material field, the solvent vapors absorption system is often referred to the “oil absorption system” or to the “mineral oil absorption system”. However, those denominations correspond only to the most commonly used technology. Indeed, the absorbing liquid is often mineral oil but not always. For example, vegetable oil or fully synthetic liquids can be used as well. Those fully synthetic liquids may be commercially designed as “oils”, but they have nor the composition nor the origin of mineral oils and/or vegetable oils.

Thus, the solvent absorption takes place into a cold liquid, usually mineral oil. After absorbing the solvent, the solvent laden liquid is heated and then the solvent is steam stripped from the solvent laden liquid under medium vacuum which results in water and solvent vapors, and a hot stripped liquid. The hot, stripped liquid is then cooled and circulated back for absorption, forming a closed loop solvent vapors absorption system. With current technology, the steam stripping is realized under a medium vacuum usually ranging from about 200 mbara to about 500 mbara, even more preferably ranging from about 300 mbara to about 400 mbara and resulting in a partial desolventization of the solvent laden liquid. Typically, about 0.2% by weight of solvent will remain in the stripped liquid. Nonetheless, such partial desolventization is currently satisfactory in most of the cases and allows to keep the discharged desolventized air stream low enough in residual solvent to meet present emission site requirements (7 to 10 g of solvent per cubic meter of air).

FIG. 1 is a schematic representation of the typical process used to desolventize various air/solvent vapors streams resulting from one or more item(s) of installations operated for the solvent extraction of oleaginous vegetable materials, said process being based on current state-of-the-art solvent vapors absorption system (100). Usually, before being processed by the solvent vapors absorption system, said stream of air solvent vapors is cooled at temperature ranging from 10° C. to 30° C.

The two main components of the solvent vapors absorption system (100) are the scrubber (101), which is also named “absorber” in the field, and the stripper (102). The air/solvent vapors stream (103), which is typically the merge of various air/solvent vapors streams emitted by different items of a solvent extraction facility, enters the bottom of the scrubber and rises to the top pulled by a fan or a steam ventilator (104) and is therefore contacted counter-currently with a cold (about 20° C. to about 40° C.) partially desolventized liquid introduced at the top (105) of the scrubber (101). The scrubber is typically filled with a packing material, in order to increase the contact surface between the rising air/solvent vapors stream and the trickling down cold liquid. Consequently, a substantial fraction of solvent contained in the rising air/solvent vapors stream is progressively absorbed by the cold liquid and therefore a solvent laden liquid exits (106) the bottom of the scrubber (101) and, simultaneously, a desolventized air stream pulled by the fan (104) exits (107) from the top of said scrubber (101) to be discharged to the atmosphere, in most of the cases, or optionally, sent to air post-treatment equipment (i.e. bio bed filters, thermal oxidizers, etc.). The solvent laden liquid is conducted at the top (108) of the stripper (102) after being pre-heated by a liquid/liquid heat-exchanger (109) and a final heater (110) at a temperature ranging typically from about 90° C. to about 110° C. Stripping medium (111) such as steam is introduced at the bottom of the stripper (102). The stripper (102) is also equipped of adequate packing material. Consequently, in the stripper, the rising stripping steam will remove the solvent contained in the trickling down solvent laden liquid and therefore a partially desolventized liquid (112) exits at the bottom of the stripper and a stream of solvent and water vapors (113) exits the top of the stripper (102). The stream of solvent and water vapors are then conducted to the main solvent recovery unit of the solvent extraction facility to be condensed in the vacuum condenser (114) which typically operates under medium vacuum condition (usually between about 200 mbara to 500 mbara and preferably between about 300 mbara to 400 mbara). This vacuum condenser (114) is not a dedicated piece of equipment specifically attached to the solvent vapors absorption system but a central unit condensing all the solvent and water vapors streams of the solvent extraction facility. The resulting water/solvent condensate (115) is then phase separated in a phase separator (116) yielding to an aqueous phase (117) and condensed solvent (118). The condensed solvent (118) is recycled for the extraction of the oleaginous vegetable material as extraction solvent in the solvent extractor which is the main item of a solvent extraction facility.

The partially desolventized liquid is re-introduced (112) at the top of the scrubber (101) after having been cooled firstly the liquid-liquid heat-exchanger (109) and in a water-liquid cooler (119). The water used in such water-liquid cooler is typically the available water from a river, a body of water, the public water supply or a water cooled by a chiller. Therefore, its temperature will depend on local circumstances. Solvent is typically hexane, and the liquid is usually mineral oil which has the advantage of being chemically stable which is primordial in such closed-loop system. Furthermore, mineral oil is affordable and easily available if replacement or regular make-up is needed.

Thus, most of current solvent vapors absorption systems are using mineral oil as liquid because mineral oil is affordable and stable. However, ever-stricter regulations governing air emissions and the presence of contaminants in food will make current solvent vapors absorption systems unable to meet future expectations.

Indeed, one of the issues of current solvent vapors absorption systems is the entrainment of some mineral oil during its stripping. This mineral oil, in the form of tiny droplets and/or mist is entrained by the high velocity of the rising stripping medium (usually water vapors and solvent vapors) exiting at the top of the stripper. Since those vapors, along with the entrained mineral oil, are conducted to the main solvent recovery unit of the solvent extraction facility to be condensed, at least a substantial fraction of the entrained mineral oil will dissolve in the condensed solvent. Given that this condensed solvent is recycled in solvent extractor processing the oleaginous vegetable material, a large amount of this entrained mineral oil dissolves in the extracted vegetable oil, and therefore contaminates it. Such contamination is one of the sources of the presence of MOSH (Mineral Oil Saturated Hydrocarbons) and MOAH (Mineral Oil Aromatic Hydrocarbons) in edible vegetable oil. Even if such contamination is not new, the focus on it has intensified considerably recently due to increased consumers awareness and the development of more sensitive analytical techniques able to detect and quantify low level of contaminations. Therefore, it is expected that future edible oils specifications will contain maximal limits for MOSH and MOAH. Currently, specifications are only existing in Germany and/or for some specific end-use applications such as infant food. It is thus expected that such specifications will be applied for larger market and for any food applications. It must be pointed out that the presence of MOSH and MOAH in edible oils does not originate solely from the entrainment of some of the mineral oil in current vapors solvent absorption system. For example, MOSH and MOAH can be found in some edible oils that do not results from solvent extraction (such as palm oil for example). Indeed, this contamination can originate, for example, from air pollutants (by road traffic, industrial activities, exhaust emissions, etc.) depositing on the crops, from contaminations occurring during the harvesting and handling of the crops (by machinery lubricants, anti-dust agents, etc.), from the contamination occurring during the transportation of the seeds or the transportation of the oil in bulk and from packaging materials. Nonetheless, cancelling or substantially reducing the contamination originating from the entrainment of some of the mineral oil in current solvent vapors absorption system is one of the mandatory mitigation strategies necessary to tackle this global issue. Other actors of the edible oils production chain will have to take measures as well to limit any other sources of contaminations.

Another issue of current solvent vapors absorption systems is the release to the atmosphere of a stream of a desolventized air still containing typically about 7 to 10 g of solvent per cubic meter of air, the solvent being hexane in most of the occurrences. Such release represents an air pollution as well as a loss of solvent that must be compensated. Even if currently, the admitted concentration of solvent in the discharged air is still 7 to 10 g per cubic meter, it is expected that various jurisdictions will impose considerably lower value of solvent contained in the released air. It is speculated that some jurisdictions will impose a maximum concentration of solvent in the exhausted air as low as 1 gr per cubic meter which will require a drastic improvement of the performance currently delivered by existing solvent vapors absorption systems as known in the field. Actually, even if the former speculation is still hypothetical, a clear trend in our society is the reduction of any air emissions, in particular the VOC (volatile organic compounds) which is one of the causes of the smog and other harmful pollutions.

It must be stressed that, in existing solvent vapors absorption systems, those two contaminations issues are in fact linked. Indeed, for example, the extend of the liquid entrainment issue (usually mineral oil), could be reduced by installing at the exit of the stripper one or more very large demister(s) (inducing a substantial pressure drop) and/or by reducing the amount of stripping steam in said stripper. However, those actions would result in a less efficient stripping leaving more solvent in the desolventized liquid (usually mineral oil). Because the desolventized liquid would then contain more solvent it would be less efficient to absorb the solvent when contacted to the air/solvent vapors stream in the scrubber thus leading to higher solvent emissions in the air discharged to the atmosphere. On the opposite, the liquid could be thoroughly desolventized in the stripper by using higher vacuum and more stripping steam. This would result in a better absorption of the solvent when this thoroughly desolventized liquid is contacted to the air/solvent vapors stream in the scrubber and thus will yield to a discharged air containing less solvent. However, this solution will induce more liquid entrainment exiting the stripper. Therefore, in current solvent vapors absorption systems, a compromise between acceptable efficiency of the desolventization of the air/solvent vapors stream and acceptable liquid entrainment exiting the stripper is realized. This is why the expression “partially desolventized liquid” (112) is used to describe current solvent vapors absorption systems as depicted in FIG. 1. As a matter of fact, in current solvent vapors absorption systems, the partially desolventized liquid still contains more than about 0.1% of solvent, typically about 0.2% of solvent and the solvent laden liquid contains typically about 2% to about 5% of solvent. Therefore, it corresponds to a desolventization by steam-stripping of the solvent laden liquid of only about 94% on average.

Therefore, solutions attempting to mitigate such contamination(s) have been proposed.

Very large demister(s) could be installed on top of the stripper to mitigate liquid entrainments. However, such equipment only induces a reduction of the liquid entrainment and not its suppression and this reduction is somehow proportional to the induced pressure drop caused by the demister(s). Due to the velocity of the rising water and solvent vapors, it is unavoidable that some liquid is entrained, especially in the form of mist. Furthermore, this solution will negatively impact the issue of the residual solvent contaminating the discharged air since the pressure drop will diminish the stripping performance of the stripper which will result in leaving more solvent in the steam-stripped liquid and this one will consequently absorb less solvent from the air/solvent vapors stream in the scrubber. Such behavior is linked with the stripper operating pressure: the higher the pressure, the lower the stripping efficiency; large demisters would result in high pressure drop, thus high working pressure and lower solvent stripping performance. Therefore, this solution may reduce partially one of the contamination issues (i.e., the liquid entrainment) faced by current solvent vapors absorption systems but worsen the second contamination issue (i.e., the residual solvent still contaminating the discharged air).

WO 2019/113289A1 discloses the replacement of the liquid, (which is usually mineral oil) by crude vegetable oil, as a matter of fact the crude vegetable oil that is obtained in the solvent extraction facility where the solvent vapors absorption systems is installed. Therefore, the entrainment of the oil during its stripping is not problematic provided the crude vegetable oil is replaced continuously to avoid its degradation. However, crude vegetable oil contains many impurities than can lead to the fouling of the stripper and scrubber internals (packing and liquid distributors) and, as well, to the fouling the heat exchanger which will inevitably imposes frequent, long, and expensive cleaning downtimes and even frequent replacement of costly pieces of equipment. To our knowledge this solution has not been put into practice at least in major production facilities.

Therefore, some installations are using refined vegetable oil instead of crude vegetable oil to replace the usual mineral oil. This solution solves at least partially the fouling issue, but since in practice, the refined vegetable oil is considerably less stable than mineral oil, the refined vegetable oil must be frequently replaced, and therefore this solution requires the handling of a rather large volume of refined vegetable oil. This represents a loss since the replaced vegetable oil is recycled as crude vegetable oil having less value (since it contains solvent). Furthermore, it imposes a substantial logistic constrains particularly for extraction facilities not integrated to a vegetable oil refining plant. To our knowledge this solution has been put in place in only a very few solvent extraction facilities and is clearly not a straightforward modification of current solvent vapors absorption systems.

Some mineral oil suppliers are proposing food-grade mineral oils known in the field as medicinal white mineral oils, but those ones still contain MOSH and therefore the liquid (usually mineral oil) entrainment at the top exit of the stripper is still problematic. Recently, synthetic “oils” have been promoted by some chemicals suppliers as containing no MOSH and no MOAH, but to our knowledge, their efficiency and stability and their contamination effect into edible vegetable oil remain unknown when used continuously and for a long period of time in industrial installations. Actually, the vegetable oil solvent extraction industry does not yet have the hindsight to judge the effectiveness of this solution and to identify the potential problems it could generate.

As a matter of fact, the vegetable oil solvent extraction industry is characterized by a prudent approach and prefers the improvement of an established and controlled technology rather than switching to a radically new technical solution that could trigger new and unknown issues on the long run. The vegetable oil solvent extraction industry will favor a technical improvement easily and rapidly implementable in existing solvent vapors absorption systems. Minimum downtime for the installation is a prerequisite. It must be pointed out the fan (104) pulling the released air from the scrubber imposes a slight negative pressure in all key items of a solvent extraction facility which is primordial on a safety point of view to preclude solvent leakages to the atmosphere. Therefore, switching off the solvent vapors absorption systems induces the full shut-down of the solvent extraction facility which stresses even more the importance of providing efficient and reliable solvent vapors absorption systems.

### OBJECT OF THE INVENTION

Thus, there is a need in the field to improve the performances of current solvent vapors absorption system. In particular, given the strengthening of future air emission and food contamination regulations, there is an urgent need in the field to considerably reduce the contamination generated by excessive release of solvent in the atmosphere, or the contamination generated by excessive entrainment of the liquid (mineral oil in most instances) in the recovered solvent, or to reduce both types of contaminations simultaneously. Furthermore, there is a need for an improvement that does not induce cleaning down-times, recurrent financial losses, logistic constrains, and that does not rely on radically new technical solutions that could trigger new and unknown issues on the long run. Furthermore, the technical solution according to the present invention should be reliable and implementable easily and rapidly in existing solvent vapors absorption systems.

### ADVANTAGES OF THE INVENTION

The process according to the present invention has the advantage of increasing the overall performances of solvent vapors absorption system, in particular it reduces significantly the release of solvent in the atmosphere and/or reduces considerably the contamination generated by liquid entrainment ending-up in the recovered solvent and, ultimately eventually being found in the vegetable oil as well. Furthermore, the present invention does not impose logistic constrains, does not impose the replacement of the traditionally used liquid (usually mineral oil) by unknown liquid potentially unstable and triggering new and unknown issues, and does not lead to the fouling of any components of the solvent vapors absorption system. As a matter of fact, even if the present invention does not impose the replacement of the liquid, it will remain advantageous for any absorbent liquid including refined vegetable oil, medicinal white mineral oil or synthetic oils. Furthermore, the process according to the present invention is modular, reliable, easily implementable in existing installations and thus retrofitting is straightforward and adaptable to local regulations imposing specific lower contamination limits for various contaminants.

These and other advantages will become apparent from the description of the process according to the present invention and the examples.

### SUMMARY OF THE INVENTION

It has surprisingly been observed that a continuous process for improving the efficiency of a solvent vapors absorption system can be obtained if said solvent vapors absorption system includes at least a scrubber, a medium vacuum stripper, and a deep vacuum stripper and if said continuous process further comprises the steps of:
a) providing a stream of air/solvent vapors resulting from one or more item(s) of a solvent extraction facility processing vegetable oleaginous material,
b) providing a stream of a liquid circulating in said solvent vapors absorption system, said liquid being in at least three different forms i.e., a desolventized liquid, a partially desolventized liquid and a solvent laden liquid,
c) providing a first and a second stream of stripping medium,
d) contacting counter-currently, within the scrubber, the stream of air/solvent vapors to the desolventized liquid stream to obtain a stream of solvent laden and a stream of desolventized air,
e) contacting counter-currently, within said medium vacuum stripper, said stream of solvent laden liquid with the stream of the first stripping medium to obtain a stream of partially desolventized liquid and a first stream of solvent and water vapors,
f) contacting counter-currently within the deep vacuum stripper, the stream of partially desolventized liquid to the second stream of stripping medium to obtain a second stream of solvent and water vapors, and a stream of desolventized liquid which is used in step d).

The invention also encompasses the continuous process as previously described wherein said desolventized liquid obtained in step f) contains less than 0.02% (w/w) of solvent and wherein said stream of desolventized air obtained in step d) contains less than 0.1% (w/w) of solvent.

The invention also encompasses the continuous process as previously described wherein the stripping mediums contain steam.

The invention also encompasses the continuous process as previously described wherein the deep vacuum stripper is created by an electrical vacuum pump, or a water ring pump, or a steam ejector.

The invention also encompasses the continuous process as previously described wherein the vacuum of the deep vacuum stripper is created with a steam ejector for which the first stripping medium is used as motive steam and wherein the second stream of solvent and water vapors obtained in step f) is merged with the first stripping medium downstream the steam ejector.

The invention also encompasses the continuous process as previously described wherein the first stripping medium contains solvent vapors.

The invention also encompasses the continuous process as previously described wherein the first stream of solvent and water vapors obtained in step e) is condensed in a dedicated vacuum condenser, which is independent from the rest of the solvent extraction plant, to recover a solvent phase and an aqueous phase.

The invention also encompasses the continuous process as previously described wherein the desolventized liquid is cooled at a temperature ranging between 10° C. and 30° C. prior being used in the scrubber.

The invention also encompasses the continuous process as previously described wherein the liquid contains at least 95% (w/w) of mineral oil, white medicinal mineral oil, synthetic oil, refined vegetable oil or any blends thereof.

The invention also encompasses the continuous process as previously described wherein the stream of air/solvent vapors provided in step a) is produced from any unit of an oleaginous vegetable material solvent extraction facility using hexane as solvent, and said stream of air solvent vapors is optionally cooled at temperature ranging from 10° C. to 30° C.

The invention also encompasses the continuous process as previously described wherein the liquid circulating in said solvent vapors absorption system is circulating in a closed loop.

The invention also encompasses the continuous process as previously described wherein the first stream of solvent and water vapors is introduced in a vacuum condenser to obtain a condensate, the condensate being introduced in a reboiler to obtain stream of wastewater and a stream of evaporated solvent vapors.

The invention also encompasses the continuous process as previously described wherein the first stream of solvent and water vapors is introduced in a vacuum condenser to obtain a condensate, the condensate being introduced in a reboiler to obtain a stream of wastewater and a stream of evaporated solvent vapors subsequently condensed to obtain a condensate which is phase separated to yield condensed solvent containing less than 1 ppm (w/w) of liquid.

Furthermore, it has surprisingly been observed that a continuous process for improving the efficiency of a solvent vapors absorption system can be obtained if said solvent vapors absorption system includes at least a scrubber and a medium vacuum stripper, and optionally a deep vacuum stripper, and said continuous process comprises the following steps:
a) providing a stream of air/solvent vapors resulting from one or more item(s) of a solvent extraction facility processing vegetable oleaginous material,
b) providing a stream of a liquid circulating in said solvent vapors absorption system, said liquid being in different forms i.e., a partially desolventized liquid and a solvent laden liquid, and optionally a desolventized liquid
c) providing a first and optionally a second stream of stripping medium,
d) contacting counter-currently within said scrubber said stream of air/solvent vapors to said partially desolventized liquid stream or optionally to said desolventized liquid to obtain a stream of solvent laden liquid and a stream of desolventized air,
e) contacting counter-currently within said medium vacuum stripper said stream of solvent laden liquid with said first stream of stripping steam to obtain a stream of partially desolventized liquid and a first stream of solvent and water vapors,
and wherein said first stream of solvent and water vapors is introduced in a dedicated and independent vacuum condenser from the rest of the solvent extraction plant to obtain a condensate, the condensate being introduced in a reboiler to obtain a stream of wastewater and a stream of evaporated solvent vapors.

The invention also encompasses the continuous process as previously described wherein the stream of evaporated solvent vapors is condensed to obtain a condensate which is phase separated to yield condensed solvent.

The invention also encompasses the continuous process as previously described wherein the stream of partially desolventized liquid is introduced in the optional deep vacuum stripper where said stream of partially desolventized liquid is further stripped by the optional second stream of stripping medium to obtain a second stream of solvent and water vapors and a stream of desolventized liquid containing less than 0.02% (w/w) of solvent.

The invention also encompasses the continuous process as previously described wherein the partially desolventized liquid or the desolventized liquid is cooled at a temperature ranging from 10° C. to 30° c. prior its introduction at the top of the scrubber.

The invention also encompasses the continuous process as previously described wherein the liquid contains at least 95% (w/w) of mineral oil, white medicinal mineral oil, synthetic oil, refined vegetable oil or any blends thereof.

The invention also encompasses the continuous process as previously described wherein the stream of air/solvent vapors is produced from any unit of an oleaginous vegetable material solvent extraction facility using hexane as solvent.

The invention also encompasses the continuous process as previously described wherein the optional second stripping medium contains steam.

The invention also encompasses the continuous process as previously described wherein the vacuum of the optional deep vacuum stripper is created with an electrical vacuum pump, or a water ring pump, or a steam ejector.

The invention also encompasses the continuous process as previously described wherein the vacuum of the optional deep vacuum stripper is created with a steam ejector for which the first stripping medium is used as motive steam and wherein the second stream of solvent and water vapors obtained in step f) is merged with the first stripping medium downstream the steam ejector.

The invention also encompasses the continuous process as previously described wherein the first stripping medium contains solvent vapors.

The invention also encompasses the continuous process as previously described wherein the liquid circulating in said solvent vapors absorption system is circulating in a closed loop.

The following description and the drawings disclose various illustrative aspects. Some improvements and novel aspects may be expressly identified, while others may be apparent from the description and drawings.

### Definitions

Liquid: In the context of the present invention the term “liquid” refers to an absorbent liquid utilized in solvent vapors absorption systems said liquid circulating in a closed loop way in said solvent vapors absorption systems. Liquid is preferably mineral oil including white medicinal mineral oil complying with Europe and US Pharmacopoeia (which is known is the field as white mineral oil). However, refined vegetable oil, synthetic liquids, or any suitable absorbent liquids or blends thereof may be used and will benefit of the advantages of the process according to the present invention. The liquid has the ability of absorbing and releasing solvent. Therefore, the present invention will use notably desolventized liquid, partially desolventized liquid and solvent laden liquid. However, when trickling down in a scrubber and/or in one or more stripper, the concentration of solvent in the liquid will respectively rises or decreases and therefore its solvent concentration is indetermined and the simple term ‘liquid’ may be used. As a matter of fact, the simple term ‘liquid” may designate desolventized liquid or partially desolventized liquid or solvent laden liquid or a liquid containing any concentration of solvent.

Scrubber: In the context of the present invention, the term “scrubber” refers to a vertically erected column vessel also known in the field as “scrubbing column” or “absorption column”. The scrubber is preferably packed with a packing material but could also be equipped with trays instead or be equipped both with packing material and with one or more tray(s). In the scrubber, a stream of desolventized liquid is contacted counter-currently with a stream of air/solvent vapors and both streams are preferably cold i.e., having a temperature of about 10 to 30° C. The stream of desolventized liquid is introduced essentially at the top of the scrubber through a liquid distributor at the top of the said scrubber. The liquid then cascades evenly down through the packing and/or tray(s), eventually dripping into a reservoir at the bottom of the scrubber. The air/vapors stream enters near the bottom of the scrubber and rises upward through the packing and/or tray(s), with the solvent fraction of said air/vapors stream being progressively absorbed into the liquid as said air/vapors stream rises, yielding finally a stream of desolventized air, containing less than 0.1% by weight of solvent and a stream of solvent laden liquid containing typically about 2% to about 5% by weight of solvent. The desolventized air then exits from the top of the scrubber pulled by a fan or steam ventilator. The solvent laden liquid is continually pumped from the bottom reservoir, heated and conducted to a stripper for further processing. Usually, the scrubber is operating just below atmospheric pressure due to the moderate depression created by the pulling fan or steam ventilator.

Stripper: In the context of the present invention, the term “stripper” refers to a vertically erected column vessel maintained under below atmospheric pressure and also known in the field as “stripping column”. The stripper is preferably packed with a packing material but could also be equipped with trays instead or be equipped both with packing material and with one or more tray(s). A stripper may also contain a flash chamber, at the top of said stripper where a fraction of the solvent evaporates directly and rapidly under the influence of the vacuum. Hot, solvent-rich liquid (usually mineral oil) enters a vacuum flash chamber, where a portion of the solvent evaporates. The hot liquid then flows into the distributor at the top of the packing section, where the liquid cascades evenly down through packing, eventually dripping into the bottom reservoir. Stripping steam enters near the bottom of the column and rises upward through the packing, with the solvent being stripped out of the hot liquid as the steam rises. The combination of solvent vapors and water vapors then exits through an entrainment separator at the top of the stripper which is able to catch a part of the entrained liquid without inducing excessive pressure drop. The present invention may make use of two strippers: a medium vacuum stripper and a deep vacuum stripper. The medium vacuum stripper is typically operating under a pressure ranging from about 200 mbara to about 500 mbara, even preferably under a pressure ranging from about 300 mbara to about 400 mbara. The deep vacuum stripper is typically operating under a pressure ranging from about 10 mbara to about 200 mbara, even preferably under a pressure ranging from about 20 mbara to about 100 mbara.

### BRIEF DESCRIPTION OF THE DRAWINGS

The accompanying drawings illustrate various systems, apparatuses, devices and methods, in which like reference characters refer to like parts throughout, and in which:

FIG. 1. is a schematic representation of a typical current process in use to desolventize the air/solvent vapors streams generated by various items of installations utilized for the solvent extraction of oleaginous vegetable materials.

FIG. 2 is a schematic representation of an embodiment of the process according to the present invention for improving the efficiency of a solvent vapors absorption system, in particular, it reduces considerably the contaminants released by said solvent vapors absorption system (200) and allows to decrease substantially the solvent contamination of the discharged air emitted by said solvent vapors absorption system, i.e., the residual solvent contaminating said discharged air is significantly reduced compared to current processes.

FIG. 3 is a schematic representation of a preferred embodiment of the process according to the present invention for improving the efficiency of a solvent vapors absorption system, in particular, it reduces considerably the contaminants released by said solvent vapors absorption system (200) and allows to decrease substantially the solvent contamination of the discharged air emitted by said solvent vapors absorption system, i.e., the residual solvent contaminating said discharged air is significantly reduced compared to current processes.

FIG. 4 is a schematic representation of another embodiment of the process according to the present invention and allowing to decrease substantially the contamination of the solvent ultimately recovered by the solvent vapors absorption system (400), i.e., the recovered solvent is nearly pure and does not contain substantial amount of the liquid that is used in said solvent vapors absorption system.

FIG. 5 is a schematic representation of another preferred embodiment of the process according to present invention and allowing to decrease substantially the contamination of the released air emitted by the solvent vapors absorption system (500), i.e., the residual solvent present in the air discharged by said solvent vapors absorption system is significantly reduced compared to current practices, and furthermore, it decreases substantially the contamination of the solvent ultimately recovered by the solvent vapors absorption system, i.e., the recovered solvent is nearly pure and does not contain substantial amount of the liquid that is used in said solvent vapors absorption system.

The invention may be embodied in several forms without departing from its spirit or essential characteristics. The scope of the invention is defined in the appended claims, rather than in the specific description preceding them. All embodiments that fall within the meaning and range of equivalency of the claims are therefore intended to be embraced by the claims.

### DETAILED DESCRIPTION

Reference will now be made to exemplary embodiments, examples of which are illustrated in the accompanying drawings. It is to be understood that other embodiments may be utilized and structural and functional changes may be made. Moreover, features of the various embodiments may be combined or altered. As such, the following description is presented by way of illustration only and should not limit in any way the various alternatives and modifications that may be made to the illustrated embodiments. In this disclosure, numerous specific details provide a thorough understanding of the subject disclosure. It should be understood that aspects of this disclosure may be practiced with other embodiments not necessarily including all aspects described herein, etc.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

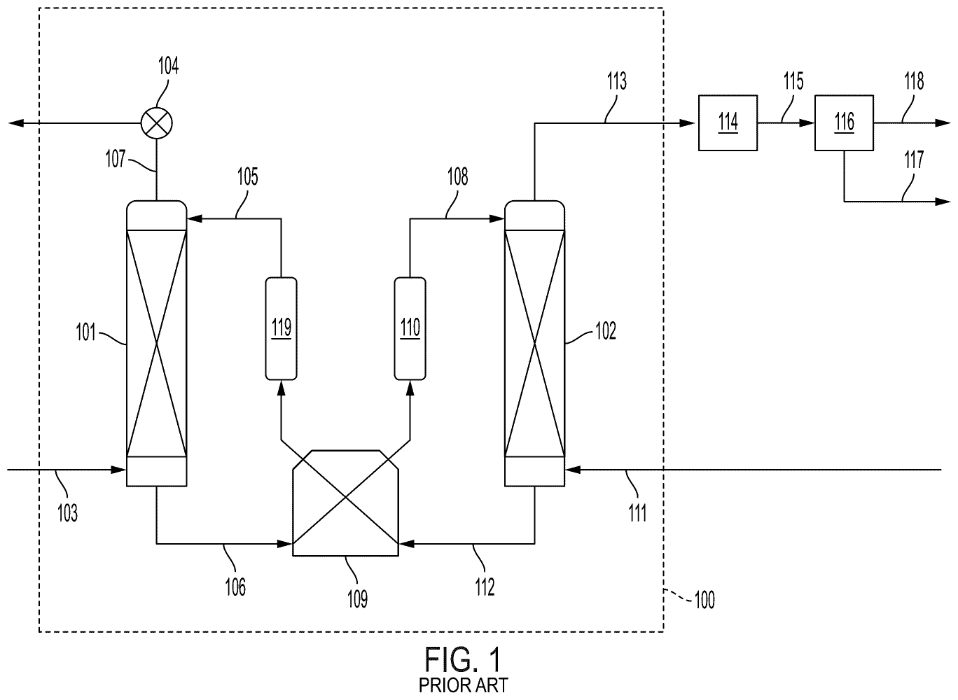

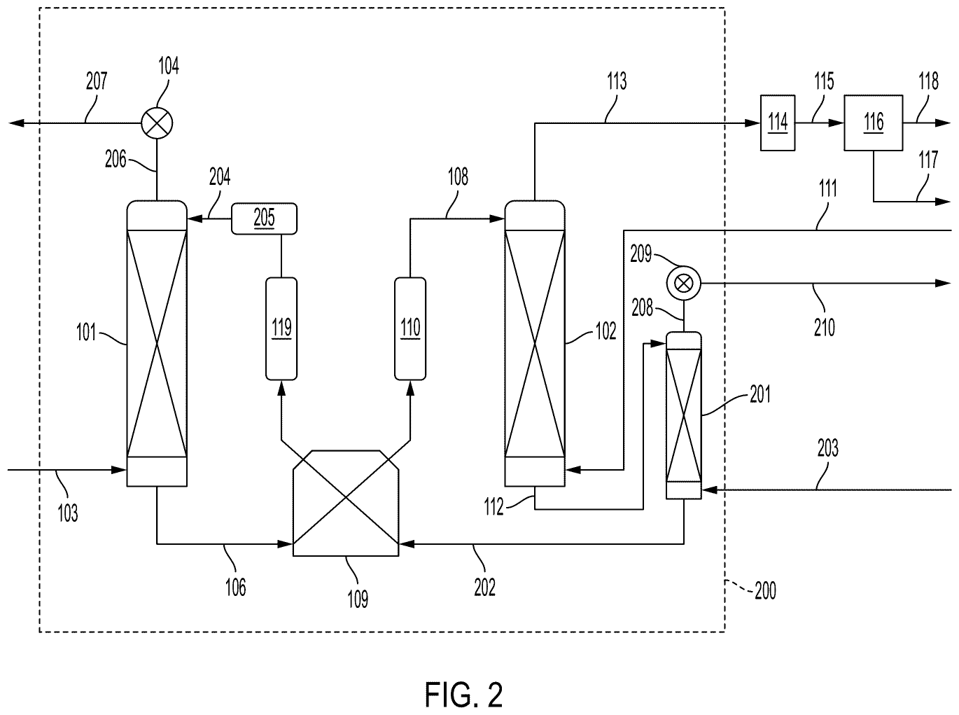

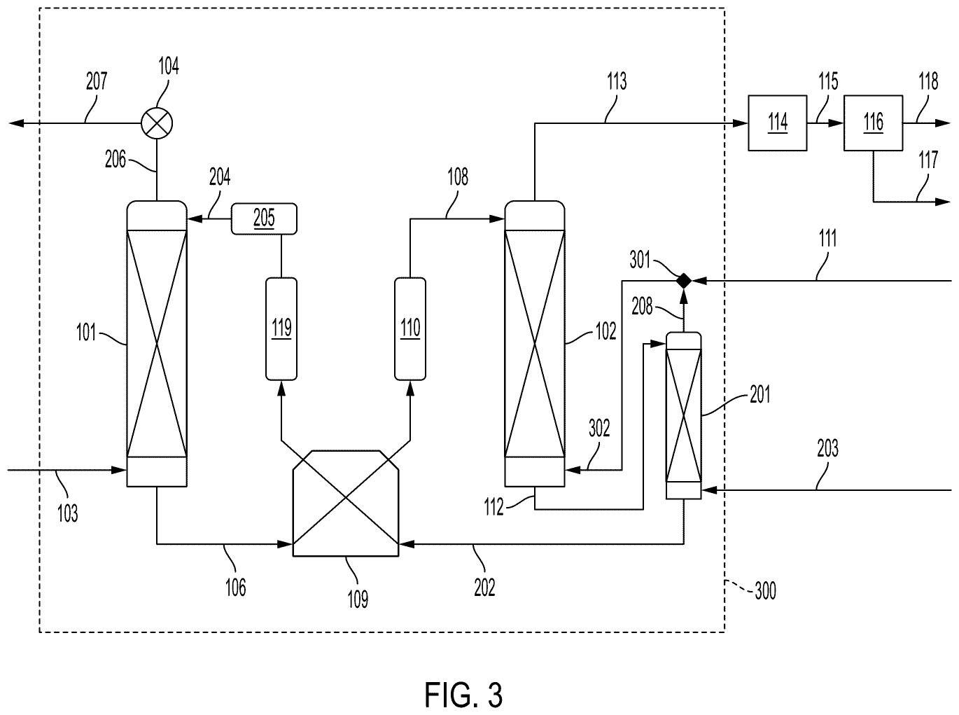

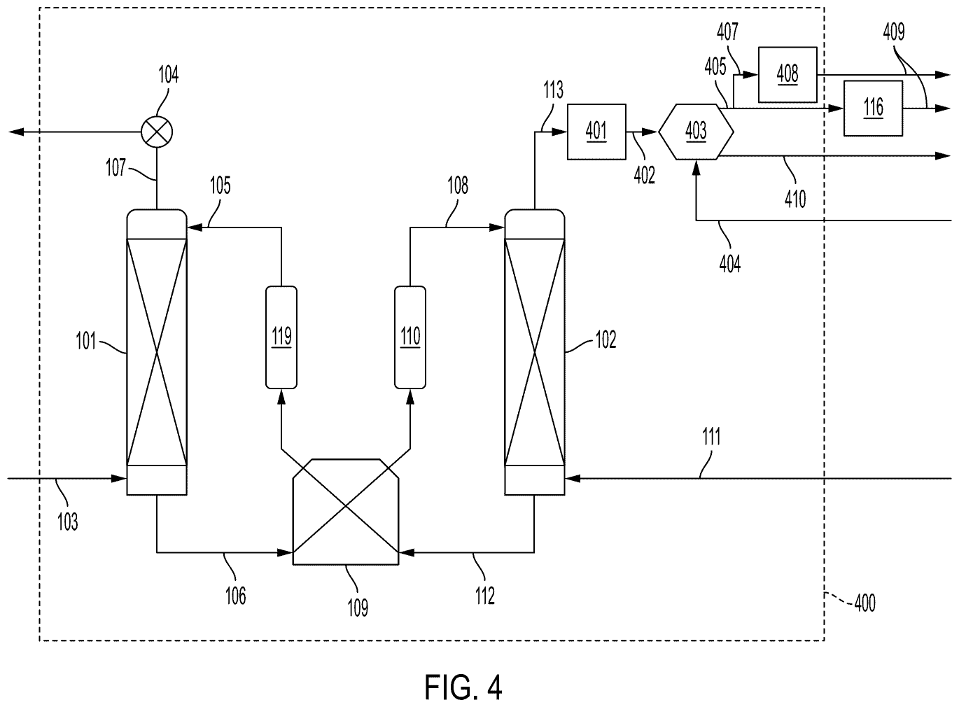

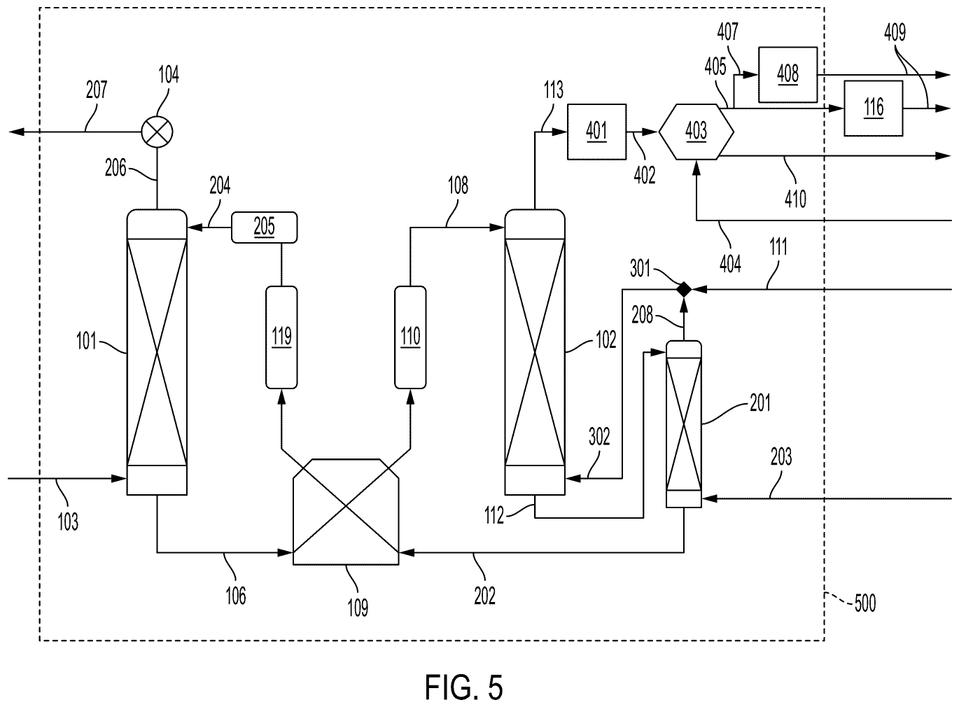

The invention will be disclosed with the support of FIG. 2, FIG. 3, FIG. 4, and FIG. 5 which are illustrating various embodiments of the process according to the present invention. However, those figures should not be construed to limit the scope of the present invention. The invention will only be limited by the appended claims. In FIG. 1, FIG. 2, FIG. 3, FIG. 4, and FIG. 5 the same numbers designate identical elements and therefore those identical elements are not systematically discussed when depicting FIG. 2, FIG. 3, FIG. 4, and FIG. 5 in order to avoid redundancies.

FIG. 2 illustrates an embodiment of the process according to present invention generally improving the efficiency of solvent vapors absorption system and allowing to decrease substantially the contamination of the air discharged by the solvent vapors absorption system (200), i.e., the residual solvent contaminating said discharged air is significantly reduced compared to current processes. Remarkably, this is attained without worsening the entrainment of the liquid from the stripper. This is achieved with a continuous process generally illustrated in FIG. 2. said continuous process including at least a scrubber (101), a medium vacuum stripper (102) and a deep vacuum stripper (201), said continuous process including the steps of a) providing a stream of air/solvent vapors (103) resulting from one or more item(s) of a solvent extraction facility processing vegetable oleaginous material(s), b) providing a stream of a liquid circulating, preferably in a closed loop in said solvent vapors absorption system (200), said liquid being in at least three different forms i.e., a desolventized liquid (202), a partially desolventized liquid (112) and a solvent laden liquid (106), c) providing a first (111) and a second (203) stream of stripping medium, d) contacting counter-currently, within the scrubber (101), the stream of air/solvent vapors (103) to a stream of cooled desolventized liquid (204) which have been cooled by passing the desolventized liquid (202) through a heat-exchanger (109), through a cooler (119) and optionally through a chiller (205), to obtain a stream of solvent laden liquid (106) and the stream of desolventized air (206) which is typically pulled by a fan or a steam ventilator (104) and discharged to the atmosphere (207), e) contacting counter-currently, within said medium vacuum stripper, said stream of heated solvent laden liquid (108) which have been heated by passing the solvent laden liquid (106) though a heat exchanger (109) and a heater (110), with the stream of the first stripping medium (111) to obtain a stream of partially desolventized liquid (112) and a first stream of solvent and water vapors (113) exiting said medium vacuum stripper (102), f) contacting counter-currently within the deep vacuum stripper (201) the stream of the partially desolventized liquid (112) to the second stream of stripping medium (203) to obtain a second stream of solvent and water vapors (208), and a stream of desolventized liquid (202) which is used in previous step d). Typically, a vacuum device (209) such as an electrical vacuum pump, a water-ring pump or a steam ejector is used to create the low pressure in the deep vacuum stripper (201). The pulled second stream of solvent and water vapors (210) can be for example condensed is a dedicated vacuum condenser or merged in another stream of solvent and water vapors. Surprisingly, the desolventized liquid (202) obtained in step f) contains less than 0.02% (w/w) of solvent and the stream of desolventized air (206) obtained in step d) contains less than 0.1% (w/w) of solvent. The first stream of solvent and water vapors (113) exiting the medium vacuum stripper (102) is conducted to the general vacuum condenser (114) of the solvent extraction facility to be condensed. The resulting condensate (115) is conducted to a decanter (116) yielding a heavy aqueous phase (117) typically headed to a water reboiler (also known as water stripper or wastewater stripper) and discarded after proper purification treatments, and condensed solvent (118) which is recycled as extraction solvent.

FIG. 3 illustrates a preferred embodiment of the process according to present invention generally improving the efficiency of solvent vapors absorption system and allowing to decrease substantially the contamination of the released air discharged by the solvent vapors absorption system (300), i.e., the residual solvent contaminating said discharged air is significantly reduced compared to current processes. This preferred embodiment is closely derived from the embodiment described in FIG. 2. However, the vacuum device creating the low pressure in the deep vacuum stripper (201) is a steam ejector (301) and the first stream of stripping steam (111) is used as motive steam of said ejector. Consequently, the second stream of solvent and water vapors (208) exiting the deep vacuum stripper is merged with the first stream of stripping steam. Thus, the first stream of stripping medium (302) contains steam and solvent vapors. This preferred embodiment is thus economical. Furthermore, the liquid that is entrained from and exits the deep vacuum stripper along with the second steam of solvent and water vapors (208) will be substantially recovered in the medium vacuum stripper. It must be noted that the deep vacuum (of typically less than 100 mbara) conjugated to the small size of the deep vacuum stripper (201) is likely to induce some liquid entrainment in the second stream of solvent and water vapors (208). However, by merging the second stream of solvent and water vapors (208) to the first stream of stripping steam (111) the final liquid entrainment exiting the medium vacuum stripper (102) is maintained to its usual level. As a matter of fact, directly applying a deep vacuum in the first stripper medium vacuum stripper (102) could be efficient to reduce the residual solvent in the desolventized liquid and thus in turn reduces the residual solvent contained in the discharged air but would increase the amount the entrained (and lost) liquid due to higher velocities of the exiting vapors. This issue is solved by installing a dedicated deep vacuum stripper upstream of the medium vacuum stripper and by connecting them as described by FIG. 3.

Thus, surprisingly, it has been observed that the efficiency of solvent vapors absorption system is achieved by the adjunction of a second, deep vacuum stripper (201) typically smaller than the medium vacuum stripper (102) allowing to strip the partially desolventized liquid under deep vacuum with a second supply of stripping steam (203) which yield to a desolventized liquid (202) containing significantly less residual solvent than the partially desolventized liquid (112) produced by the medium vacuum stripper (102). It has been observed that such desolventized liquid with significantly less residual solvent (202) is much more efficient to absorb the solvent vapors in the scrubber (101) and reduces the concentration of solvent in the discharged air (207) by more than 100% up to 500% compared to partially desolventized liquid obtained by current processes. If the desolventized liquid is supplementary cooled before being introduced in the scrubber, preferably at a temperature ranging from about 10° C. to about 20° C. then the concentration of solvent in the discharged air (207) can be reduced even more and a global reduction of about 1000% can be achieved. Such temperature can be achieved with a chiller (205) for example.

Thus, the adjunction of a chiller (205) to further cool the desolventized liquid, to temperature ranging preferably between about 20° C. and about 10° C. allows to further reduce the concentration of solvent in the released air. A ten-fold reduction has been observed when a desolventized liquid having a temperature of 15° C. is introduced in the scrubber. Thus, in those conditions, the released air contains less than 0.1% of solvent on a weight/weight basis, the solvent being hexane and the liquid being white mineral oil. Furthermore, such significant reduction did not increase the amount of entrained liquid at the top exit of the medium vacuum stripper.

FIG. 4 is a schematic representation of another embodiment of the process according to the present invention allowing to decrease substantially the contamination of the solvent ultimately recovered by the solvent vapors absorption system (400), i.e., the recovered solvent is nearly pure and does not contain substantial amount of the liquid that is used in said solvent vapors absorption system. The term “nearly” is used in the expression “nearly pure” to indicate that the liquid cannot be detected by current usual analytical techniques. However, one cannot rule out that some trace of the liquid may be present in the recovered solvent at level below detection limit. Remarkably, this is realized without increasing the level of solvent contamination remaining in the discharged air. Surprisingly, this is achieved by the adjunction of a dedicated vacuum-condenser (401), where the stream of water and solvent vapors (113) are condensed. The resulting condensate (402) is conducted to a reboiler (403), also known as wastewater stripper which is operating at a temperature above the solvent boiling point, typically above 80° C. and even preferably above 90° C. but below 100° C. The temperature is adjusted by injecting live steam (404) in the reboiler. This makes the solvent to evaporate and leave the reboiler (403) as solvent and water vapors free of the liquid used in the solvent vapors absorption system (400). The solvent vapors (405) free of the liquid are then treated as known in the art i.e., conducted to the general vacuum condenser (116) of the solvent extraction facility, or optionally via optional line (407), to a dedicated condenser (408) to be condensed into a condensate (409) which is phase separated to yield a condensed solvent reused as extraction solvent and an aqueous phase.

Surprisingly, it has been observed that the condensed solvent recovered according to this embodiment has a residual liquid content below current detection limit. As a matter of fact, the liquid remains in the water phase waste stream (410) which constantly leaves the reboiler (403). This water phase waste stream is typically discarded after appropriate purification treatment(s).

Therefore, the process according to the present embodiment allows to considerably decrease the contamination of the solvent ultimately recovered by the solvent vapors absorption system (400), i.e., the recovered solvent is nearly pure and does not contain substantial amount of the liquid that is used in said solvent vapors absorption system. Remarkably, this is realized without increasing the level of solvent contamination remaining in the discharged air which is another discharge of the solvent vapors absorption system (400). Consequently, since the solvent recovered by the processes according to the present embodiment is substantially free of liquid, its recycling as extraction solvent in a solvent extraction facility for oleaginous material does not lead to the contamination of the extracted vegetable oil by unwanted substances such as, but not limited to MOSH and/or MOAH.

FIG. 5 illustrates yet another preferred embodiment of the process according to present invention and allowing to decrease substantially the contamination of the released air emitted by the solvent vapors absorption system (500), i.e., the residual solvent present in the air discharged by said solvent vapors absorption system is significantly reduced compared to current practices, and furthermore, it decreases substantially the contamination of the solvent ultimately recovered by the solvent vapors absorption system, i.e., the recovered solvent is nearly pure and does not contain substantial amount of the liquid that is used in said solvent vapors absorption system.

This preferred embodiment, illustrated by FIG. 5, makes use of a steam ejector (301) as vacuum device creating the low pressure in the deep vacuum stripper (201). The first stream of stripping steam (111) is used as motive steam of said ejector. Consequently, the second stream of solvent and water vapors (208) exiting the deep vacuum stripper is merged with the first stream of stripping steam. Accordingly, the first stream of stripping medium (302) contains water and solvent vapors. The liquid that is entrained and exits the deep vacuum stripper along with the second steam of solvent and water vapors (208) will be substantially recovered in the medium vacuum stripper. It has been observed that the desolventized liquid (202) contains significantly less residual solvent compared to current practice and is much more efficient to absorb the solvent vapors in the scrubber (101) and reduces the concentration of solvent in the released air by about 100% to about 500% compared to partially desolventized liquid obtained by current processes. If the desolventized liquid is supplementary cooled before being introduced in the scrubber, preferably at a temperature ranging from about 10° C. to about 20° C. then the concentration of solvent in the released air can be reduced even more and a global reduction of about 1000% can be achieved. Such temperature can be achieved with a chiller (205) for example. Thus, the adjunction of a chiller (205) to further cool the desolventized liquid, to temperature ranging preferably between about 20° C. and about 10° C. allows to further reduce the concentration of the remaining solvent present in the discharged air. A ten-fold reduction has been observed when a desolventized liquid having a temperature of 15° C. is introduced in the scrubber. Thus, in those conditions, the released air contains slightly less than 0.1% of solvent on a weight/weight basis, the solvent being hexane and the liquid being white mineral oil. Furthermore, such significant reduction did not increase the amount of entrained liquid at the top exit of the medium vacuum stripper.

Additionally, this preferred embodiment, illustrated by FIG. 5, allows to decrease substantially the contamination of the solvent ultimately recovered by the solvent vapors absorption system (500), i.e., the recovered solvent is nearly pure and does not contain substantial amount of the liquid that is used in said solvent vapors absorption system. Remarkably, this is realized without increasing the level of solvent contamination remaining in the discharged air. Surprisingly, this is achieved by the adjunction of a dedicated vacuum-condenser (401), where the stream of water and solvent vapors (113) are condensed. The resulting condensate (402) is conducted to a reboiler (402) which is operating at a temperature above the solvent boiling point, typically above 80° C. and even preferably above 90° C. but below 100° C. The temperature is adjusted by injecting live steam (404) in the reboiler. This makes the solvent to evaporate and leave (405) the reboiler as solvent vapors substantially free of the liquid used in the solvent vapors absorption system (400). The solvent vapors (405) free of the liquid are then treated as known in the art i.e., conducted to the general condenser (116) of the solvent extraction facility, or optionally via optional line (407), to a dedicated condenser (408) to be condensed into a condensate (409) which is phase separated to yield a condensed solvent reused as extraction solvent and an aqueous phase.

Surprisingly, it has been observed that the condensed solvent recovered according to this embodiment has a residual liquid content below current detection limit. As a matter of fact, the liquid remains in the water phase waste stream (410) which constantly leaves the reboiler (402). This water phase waste stream is typically discarded after appropriate purification treatment(s).

Therefore, this preferred embodiment, illustrated by FIG. 5, decreases substantially the contamination of the released air emitted by the solvent vapors absorption system (500), and allows to considerably decrease the contamination of the solvent ultimately recovered by the solvent vapors absorption system (500), i.e., the recovered solvent is nearly pure and does not contain substantial amount of the liquid that is used in said solvent vapors absorption system.

The choice between the disclosed embodiments illustrated in FIG. 2, FIG. 3, FIG. 4, and FIG. 5 depends on local circumstances, mainly the local legislations ruling the allowed contamination level of the released air and the level of contamination allowed in the produced edible oil. Therefore, the skilled artisan will implement the specific embodiment meeting the local legislations.

Thus, the process according to the present invention has the advantage of increasing the overall performances of solvent vapors absorption system, in particular it reduces drastically the release of one or more contaminants by said solvent vapors absorption system. Furthermore, the process according to the present invention does not impose logistic constrains, does not impose the replacement of the liquid used in said solvent vapors absorption system by unknown liquid potentially unstable and potentially triggering new and unknown issues, and does not lead to the fouling of any components of said solvent vapors absorption system. As a matter of fact, the process according to the present invention will remain advantageous for any liquid absorbent. Furthermore, the process according to the present invention is modular, easily implementable in existing installations and thus retrofitting is straightforward and adaptable to local regulations imposing specific lower contamination limits. The supplementary pieces of equipment (deep vacuum stripper 201, steam ejector 301, dedicated vacuum stripper condenser 401) can be put in place during the running time of the solvent vapors absorption system while the connection being realized during a scheduled plant stop to finish the interconnections with the existing installation, thus impacting minimally the operations.

What has been described above includes examples of the present specification. It is, of course, not possible to describe every conceivable combination of components or methodologies for purposes of describing the present specification, but one of ordinary skill in the art may recognize that many further combinations and permutations of the present specification are possible. Each of the components or methodologies described above may be combined or added together in any permutation. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A continuous process for improving the efficiency of solvent vapors absorption system, said solvent vapors absorption system including at least a scrubber, a medium vacuum stripper, and a deep vacuum stripper, said continuous process comprising the following steps:
a) providing a stream of air/solvent vapors resulting from one or more item(s) of a solvent extraction facility processing vegetable oleaginous material,
b) providing a stream of a liquid circulating in said solvent vapors absorption system, said liquid being in at least three different forms i.e., a desolventized liquid, a partially desolventized liquid and a solvent laden liquid,
c) providing a first and a second stream of stripping medium,
d) contacting counter-currently, within the scrubber, the stream of air/solvent vapors to the desolventized liquid stream to obtain a stream of solvent laden and a stream of desolventized air,
e) contacting counter-currently, within said medium vacuum stripper, said stream of solvent laden liquid with the stream of the first stripping medium to obtain a stream of partially desolventized liquid and a first stream of solvent and water vapors,
f) contacting counter-currently within the deep vacuum stripper, the stream of partially desolventized liquid to the second stream of stripping medium to obtain a second stream of solvent and water vapors, and a stream of desolventized liquid which is used in step d).

2. A continuous process according to claim 1 wherein the desolventized liquid obtained in step f) contains less than 0.02% (w/w) of solvent and wherein said stream of desolventized air obtained in step d) contains less than 0.1% (w/w) of solvent.

3. A continuous process according to claim 1 wherein the stripping mediums contain steam.

4. A continuous process according to claim 1 wherein the vacuum of the deep vacuum stripper is created with an electrical vacuum pump, or a water ring pump, or a steam ejector.

5. A continuous process according to claim 1 wherein the vacuum of the deep vacuum stripper is created with a steam ejector for which the first stripping medium serves as motive steam of said steam ejector, and wherein the second stream of solvent and water vapors obtained in step f) is merged with the first stripping medium by means of said steam ejector.

6. A continuous process according to claim 1 wherein the first stripping medium can contain solvent and water vapors.

7. A continuous process according to claim 1 wherein the first stream of solvent and water vapors obtained in step e) is condensed in a dedicated vacuum condenser, which is independent from the rest of the solvent extraction plant, to recover a solvent phase and an aqueous phase.

8. A continuous process according to claim 1 wherein the desolventized liquid is cooled at a temperature ranging between 10° C. and 30° C., and even preferably ranging between 10° C. and 20° C. prior being used in the scrubber.

9. A continuous process according to claim 1 wherein the liquid contains at least 95% (w/w) of mineral oil, white medicinal mineral oil, synthetic oil, refined vegetable oil or any blends thereof.

10. A continuous process according to claim 1 wherein the stream of air/solvent vapors provided in step a) is produced from any unit of an oleaginous vegetable material solvent extraction facility using hexane as solvent.

11. A continuous process according to claim 1 wherein the liquid circulating in said solvent vapors absorption system is circulating in a closed loop.

12. A continuous process according to claim 1 wherein said first stream of solvent and water vapors is introduced in a vacuum condenser to obtain a condensate, the condensate being introduced in a reboiler to obtain a stream of wastewater and a stream of evaporated solvent and water vapors.

13. A continuous process according to claim 1 wherein said first stream of solvent and water vapors is introduced in a vacuum condenser to obtain a condensate, the condensate being introduced in a reboiler to obtain a stream of wastewater and a stream of evaporated solvent vapors subsequently condensed to obtain a condensate which is phase separated to yield condensed solvent.

14. A continuous process for improving the efficiency of solvent vapors absorption system, said solvent vapors absorption system including at least a scrubber and a medium vacuum stripper, and optionally a deep vacuum stripper, said continuous process comprising the following steps:
a) providing a stream of air/solvent vapors resulting from one or more item(s) of a solvent extraction facility processing vegetable oleaginous material,
b) providing a stream of a liquid circulating in said solvent vapors absorption system, said liquid being in different forms i.e., a partially desolventized liquid and a solvent laden liquid, and optionally a desolventized liquid
c) providing a first and optionally a second stream of stripping medium,
d) contacting counter-currently within said scrubber said stream of air/solvent vapors to said partially desolventized liquid stream or optionally to said desolventized liquid to obtain a stream of solvent laden liquid and a stream of desolventized air,
e) contacting counter-currently within said medium vacuum stripper said stream of solvent laden liquid with said first stream of stripping steam to obtain a stream of partially desolventized liquid and a first stream of solvent and water vapors,
wherein said first stream of solvent and water vapors is introduced in a dedicated vacuum condenser, which is independent from the rest of the solvent extraction plant, to obtain a condensate, the condensate being introduced in a reboiler to obtain a stream of wastewater and a stream of evaporated solvent vapors.

15. A continuous process according to claim 14 wherein the stream of evaporated solvent and water vapors is condensed to obtain a condensate which is phase separated to yield condensed solvent.

16. A continuous process according to claim 14 wherein said stream of partially desolventized liquid is introduced in the optional deep vacuum stripper where said stream of partially desolventized liquid is further stripped by the optional second stream of stripping medium to obtain a second stream of solvent and water vapors and a stream of desolventized liquid containing less than 0.1% (w/w) of solvent.

17. A continuous process according to claim 16 wherein the partially desolventized liquid or the desolventized liquid is cooled at a temperature ranging from 10° C. and 30° C., and even preferably ranging between 10° C. and 20° C. prior its introduction at the top of the scrubber.

18. A continuous process according to claim 14 wherein the partially desolventized liquid or the desolventized liquid is cooled at a temperature ranging from 10° C. and 30° C., and even preferably ranging between 10° C. and 20° C. prior its introduction at the top of the scrubber.

19. A continuous process according to claim 14 wherein the liquid contains at least 95% (w/w) of mineral oil, white medicinal mineral oil, synthetic oil, refined vegetable oil or any blends thereof.

20. A continuous process according to claim 14 wherein the stream of air/solvent vapors is produced from any unit of an oleaginous vegetable material solvent extraction facility using hexane as solvent.

21. A continuous process according to claim 14 wherein the optional second stripping medium contains steam.

22. A continuous process according to claim 14 wherein the vacuum of the optional deep vacuum stripper is created with an electrical vacuum pump, or a water ring pump, or a steam ejector.

23. A continuous process according to claim 14 wherein the vacuum of the optional deep vacuum stripper is created with a steam ejector for which the first stripping medium serves as motive steam and wherein the second stream of solvent and water vapors obtained in step f) is merged with the first stripping medium by means of a steam ejector.

24. A continuous process according to claim 14 wherein the first stripping medium can contain solvent vapors.

25. A continuous process according to claim 15 wherein the liquid circulating in said solvent vapors absorption system is circulating in a closed loop.
